(19) United States
(12) Patent Application Publication
(10) Pub. No.: US 2006/0289697 A1
(43) Pub. Date: Dec. 28, 2006

(54) Aircraft propeller shaft support system providing propeller shaft damping

(76) Inventor: Walter Dennis Clark, Fullerton, CA (US)

Correspondence Address: LOUIS L. DACHS, 1794 PALISADES DRIVE, PACIFIC PALISADES, CA, 90272, US

(21) Appl. No.: 11/165,086

(22) Filed: Jun. 23, 2005

(51) Int. Cl. B64D 27/00

(52) U.S. Cl. 244/55

(57) ABSTRACT

The invention is a propeller support system for damping vibrations of a propeller shaft and propeller on an aircraft. In detail, the support system includes a bearing support for the propeller and a drive system to move the bearing support along the propeller shaft as a function of propeller RPM.

### BACKGROUND OF THE INVENTION

1. Field of the Invention

The invention relates to the field of propeller driven aircraft and, in particular, to a propeller mounted on an extended driveshaft and having adjustable damping.

2. Description of Related Art

Typical propeller driven aircraft have fully supported propellers, even when the engine is separated there from. For example, U.S. Pat. No. 2,153,603 Aircraft Power Plant Installation by R. C. Wells discloses an engine mounted within the wing of an aircraft near its center and a shaft driving a propeller extending out from the leading edge of the wing. As many as three separate propeller shaft supports are provided to achieve a desired weight distribution U.S. Pat. No. 4,546,939 Power Unit For Hang-Gliders by J. W. Kolecki discloses a propeller drive shaft supported almost the entire length of the glider. A damping device is employed for the purpose of preventing vibrations caused by the power plant from being transmitted to the airframe.

U.S. Pat. No. 3,286,681 Propeller Shaft Support by J. Plum discloses a flexible drive shaft for use on a boat. Here the drive shaft rotates while bowed so that the propeller is normal to the water flow where it is attached to the propeller. The bow is maintained by a front bearing mounted on a strut extending out of the bottom of the boat and an aft support that is part of the rudder, which is downstream from the propeller. U.S. Pat. No. 1,953,599 Boat Propulsion Device by G. P. Grimes discloses the typical outboard motor for a boat. Here a long drive shaft is supported by a rigid shaft which extends parallel to the drive shaft and provides a support bracket near the propeller. None of the prior art discloses the use of a propeller shaft with a flexible damper.

Thus, it is a primary object of the invention to provide flexible propeller shaft and support therefore wherein the lightness of a cantilevered shaft allows the propeller disk to be placed farther from the wing making it quieter and allowing the vertical component of the blades to aid directional stability.

It is another primary object of the invention to provide a flexible propeller shaft and support therefore that will find its own center to revolve around allowing the large rotating mass of the propeller to be entirely isolated from the rest of the vehicle.

### SUMMARY OF THE INVENTION

The invention is a propeller support system for damping vibrations of a propeller shaft having first and second ends with a propulsion system coupled to the first end and a propeller mounted on the second end. In detail, the support system includes a bearing support for the propeller shaft and an actuation system to move the bearing support along the propeller shaft as a function of propeller RPM. Preferably a flexible coupling is incorporated for connecting the first end of the propeller shaft to the propulsion system.

In one embodiment the bearing support includes an elastic damping strut having first and second ends; with the first end terminating in a bearing in slidable engagement with the propeller shaft and a second end slidably mounted to the aircraft. The actuation system is adapted to move the damping strut in a direction along the axis of the propeller shaft. Preferably the actuation system includes a hydraulic actuator coupled to the second end of the damping strut. The actuation system can be used during normal operation, or if conditions allow it, the actuation can be disabled after flight testing has found the safest fixed location.

In a second embodiment, the bearing assembly includes an inner race in slidable contact with the propeller shaft, an outer support member and a visco-elastic damping member sandwiched between the inner race and the outer support member and joined to both. The actuation system in this case includes the outer support member having a rack gear and a motor assembly with an output shaft having a pinion gear in engagement with the rack gear. Thus rotation of the pinion gear cause the outer support member to translate.

Thus the bearing assembly can be moved along the propeller shaft as a function of RPM to damp out vibrations caused by the rotation of the propeller shaft that is unsupported at the distal end.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

### BRIEF DESCRIPTION OF THE DRAWINGS

FIG. 1 is a top view of an aircraft having a pusher type propeller propulsion system.

FIG. 2 is a partial cross-sectional view of the aircraft shown in FIG. 1 taken along the line 2-2 illustrating the damping system.

FIG. 3 is a partial cross-sectional view of FIG. 1 taken along the line 3-3 shown in FIG. 2 further illustrating the damping system.

FIG. 4 a views similar to FIG. 2 illustrating a second embodiment of the invention.

FIG. 5 is a flowchart of the operation of the damping system.

FIG. 6 illustrates a damping system similar to FIG. 2 wherein the damping system is not adjustable.

FIG. 7 illustrates a damping system similar to FIG. 4 wherein the damping system is not adjustable

### DESCRIPTION OF THE PREFERRED EMBODIMENT

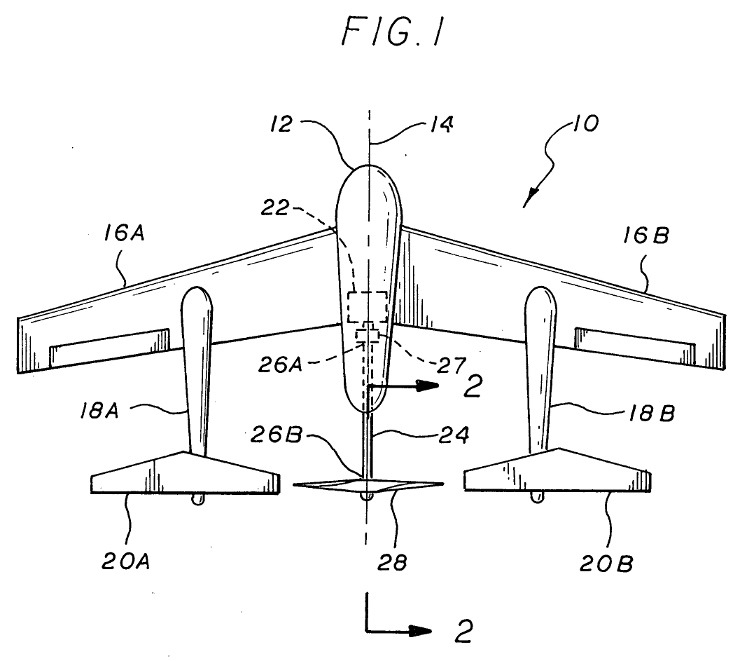

Referring to FIG. 1, the aircraft, generally designate by numeral 10, includes a fuselage 12 having a longitudinal axis 14 and a, wings 16A and 16B. Tail booms 18A and 18B extend from the wings 16A and 16B respectively and mount ruddervators 20A and 20B, respectively. A motor 22 is mounted in the fuselage 12. A propeller shaft 24 extending outward from rear of the fuselage 12 along the longitudinal axis 14 having a first end 26A coupled to the motor 22 by a coupling 27 and by its second 26B to a propeller 28.

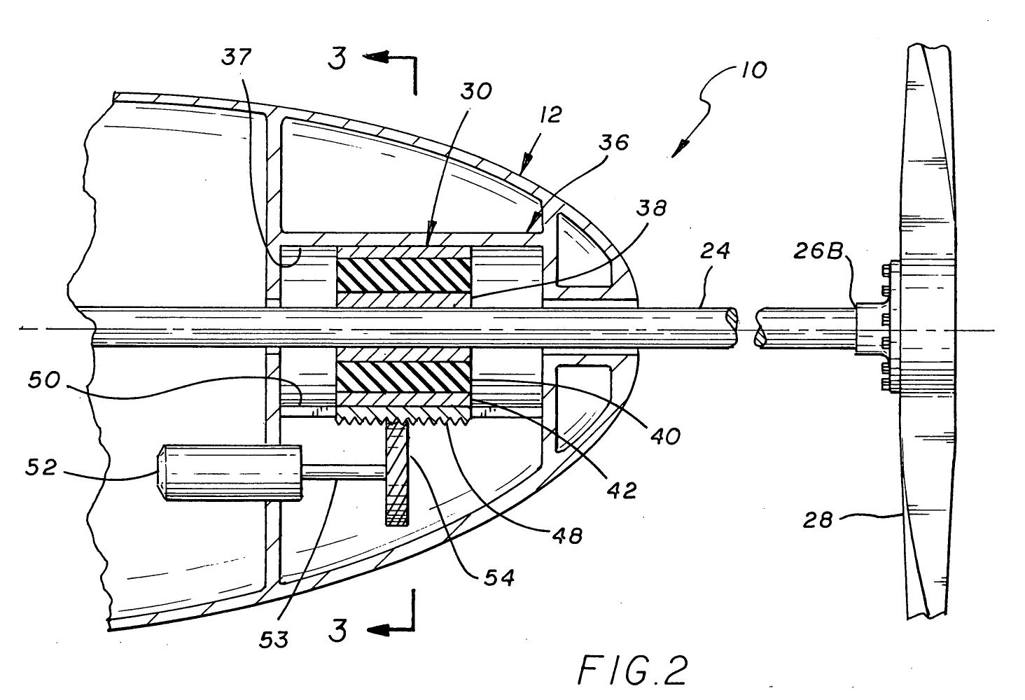

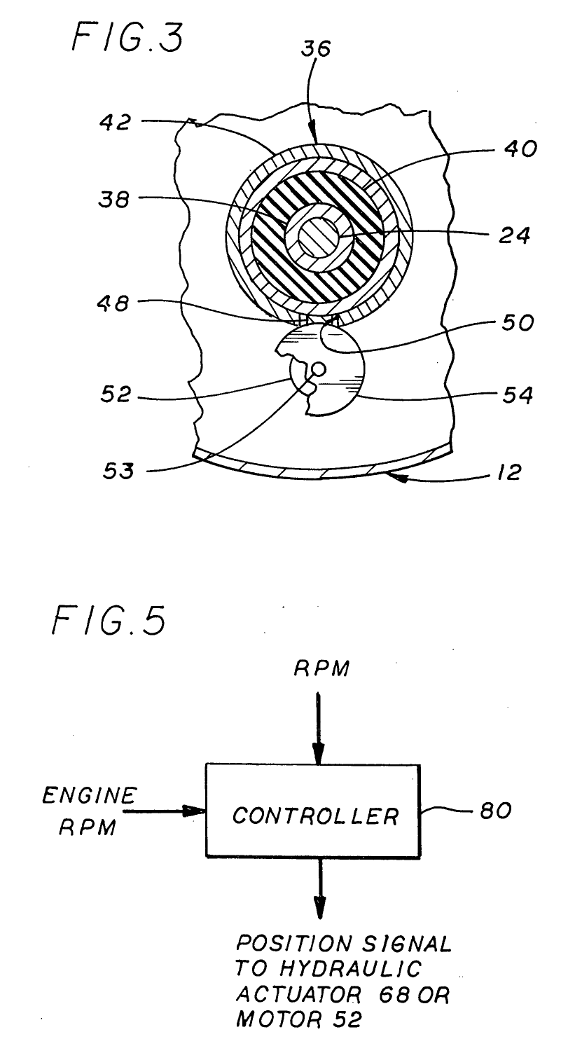

In a first version the system illustrated in FIGS. 2 and 3, a damper assembly 30 includes a bearing assembly 36 is mounted in fuselage structure that includes a bearing 38 in slidable engagement with the propeller shaft 24 some distance away from the propeller 28. A visco-lastic bushing 40 is bonded to bearing 38 and to an outer sleeve 42 movably mounted in the fuselage structure. The sleeve 42 includes a rack gear 48 that protrudes into a slot 50. A motor 52 includes an output shaft 54 terminating in a pinion gear in engagement with the rack gear 48.

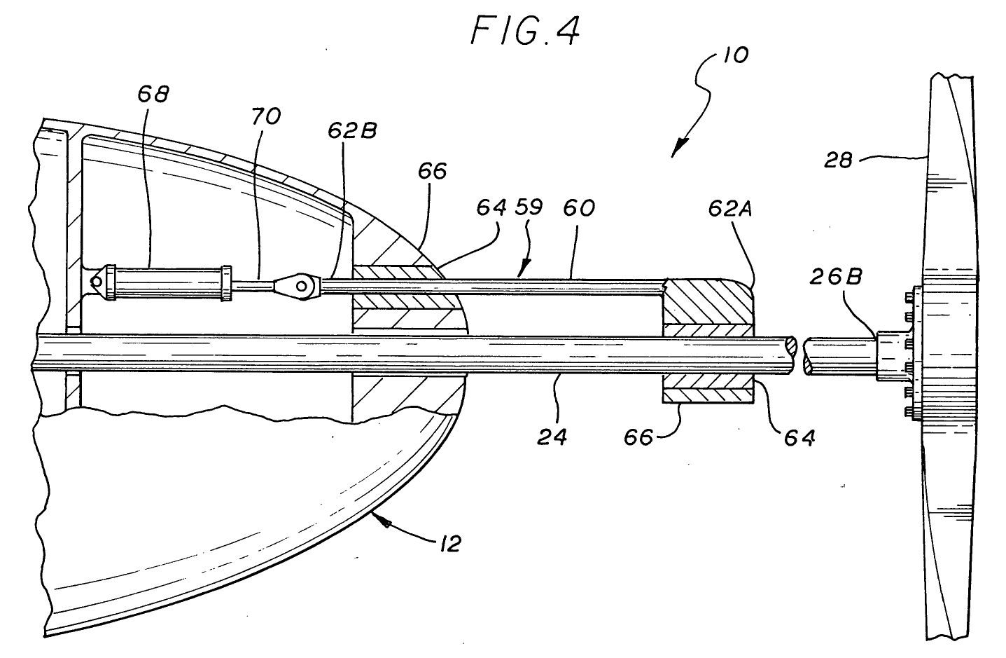

In a second version of the invention as illustrated in FIG. 4 and 5 and identified by numeral 59, a semi-flexible damping strut 60 is used. The damping strut 60 includes a first end 62A terminating in an outer bearing assembly having a bearing 64 in slidable engagement with the propeller shaft 24, which acts as an inner race. The second end 62B acts as an inner race and is slidably engagable with an outer race 66 mounted in the fuselage structure. A hydraulic cylinder 68 includes an output strut 70 in engagement with the second end 62B of the strut 60. Thus actuation of the hydraulic cylinder 68 will cause the first end 62A of the strut 60 to move fore or aft as a function of propeller shaft rotational speed to provide damping therefore.

Because the weight and balance of each propeller and shaft therefore will have some differences, it is most likely that they will have to tested upon installation on each particular aircraft. Thus each aircraft will most likely have a custom program wherein the position of the damping system on the propeller shaft will be determined as a function of propeller rotational speed. Thus referring to FIG. 5, the operation of the system will use a controller 80 that will automatically adjust the position of the damper system as a function of propeller RPM.

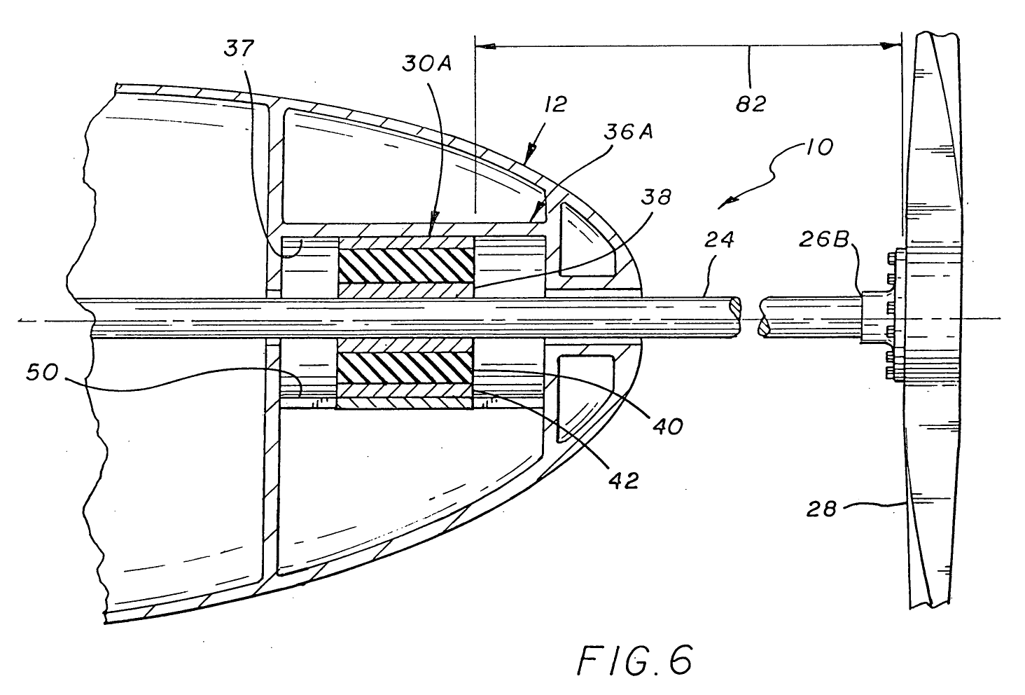

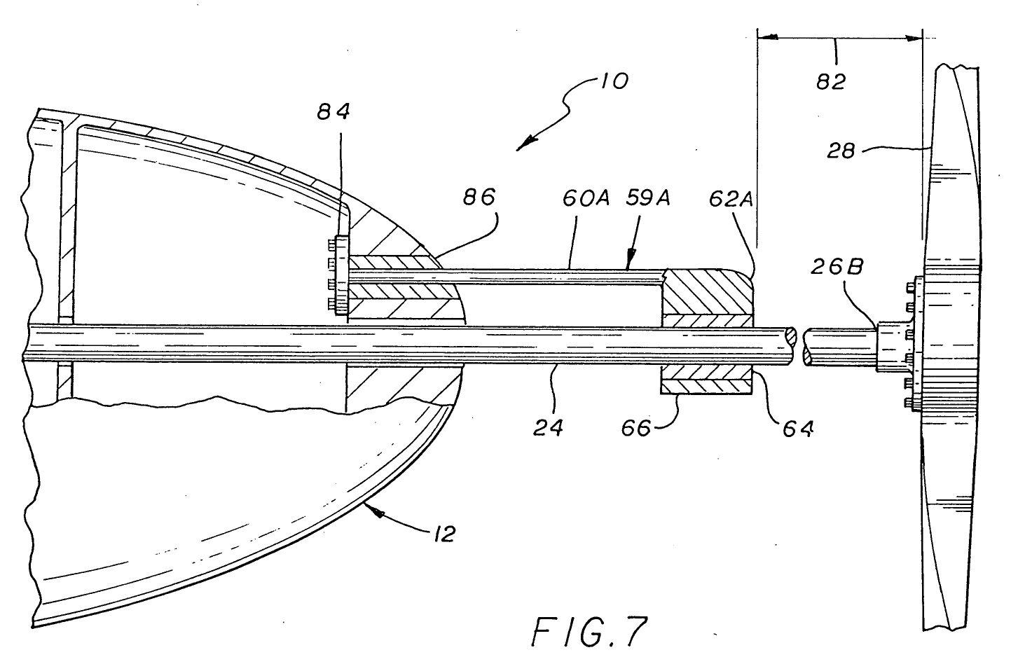

Referring to FIGS. 6 and 7, it is possible to use an unsupported driveshaft 24 and propeller 28 with a fixed position propeller shaft damping system if the unsupported length (length between the bearing and propeller) is sufficient to allow the propeller to seek its own center of rotation bearing mounting system. The damping system is still required in order to absorb vibration loads as the propeller accelerates to its operational rotational speed. Thus in FIG. 6, a non adjustable version of the damping system, now indicated by numeral 30A The aircraft structure 36A is now adapted to restrain the damping system 30A. What is critical is the length 82 of the unsupported shaft 24, which must be sufficient to allow the propeller 28 to seek its own center of rotation. Illustrated and FIG. 7, is a non adjustable version of the damping system originally shown in FIG. 4, now indicated by numeral 59A. In this case the shaft, now indicated by numeral 62A, has end 84 rigidly attached to the aircraft. However, it is desirable to have an adjustable shaft damping system to determine the optimum location of contact therewith.

While the invention has been described with reference to particular embodiments, it should be understood that the embodiments are merely illustrative as there are numerous variations and modifications, which may be made by those skilled in the art. Thus, the invention is to be construed as being limited only by the spirit and scope of the appended claims.

### INDUSTRIAL APPLICABILITY

The invention has applicability to aircraft industry.

1. A propeller support system for damping vibrations of a propeller shaft having first and second ends with a propulsion system coupled to the first end and a propeller mounted on the second end, the support system comprising:
a resilient bearing support for the propeller shaft; and
means to move the bearing support along the propeller shaft as a function of propeller RPM.

2. The propeller support system as set forth in claim 1 comprising:
a flexible coupling connecting the first end of the propeller shaft to the propulsion system.

3. The propeller support system as set forth in claim 2 wherein said bearing support comprises:
a damping strut having first and second ends; said first end terminating in a bearing in slidable engagement with the propeller shaft and a second end slidably mounted to the aircraft; and
means to move said damping strut in a direction along the axis of the propeller shaft;

4. The propeller support system as set forth in claim 3 wherein said means to move said damping strut in a direction along the axis of the propeller shaft includes a hydraulic actuator coupled to the second end of said damping strut.

5. The propeller support system as set forth in claims 2 wherein said bearing support comprises
a bearing assembly comprising
an inner race in slidable contact with the propeller shaft;
an outer support member;
an elastic damping member sandwiched between said inner race and aid outer support member and joined to both;
means to move said bearing assembly in a direction along the axis of the propeller shaft.

6. The propeller support system as set forth in claim 5 wherein said means to move said bearing assembly in a direction along the axis of the propeller shaft comprises”
said outer support member having a rack gear; and
a motor assembly with an output shaft having a pinion gear in engagement with said rack gear.

7. A propeller support system for damping vibrations of a propeller shaft having first and second ends with a propulsion system coupled to the first end and a propeller mounted on the second end, the support system comprising a resilient bearing support for the propeller shaft positioned on the propeller shaft such that the propeller is capable of finding its own center of rotation.

8. The propeller support system as set forth in claim 7 further comprising means to move the bearing support along the propeller shaft as a function of propeller RPM.

9. The propeller support system as set forth in claim 8 comprising:
a flexible coupling connecting the first end of the propeller shaft to the propulsion system.

10. The propeller support system as set forth in claim 9 wherein said bearing support comprises:
a damping strut having first and second ends; said first end terminating in a bearing in slidable engagement with the propeller shaft and a second end slidably mounted to the aircraft; and
means to move said damping strut in a direction along the axis of the propeller shaft;

11. The propeller support system as set forth in claim 10 wherein said means to move said damping strut in a direction along the axis of the propeller shaft includes a hydraulic actuator coupled to the second end of said damping strut.

12. The propeller support system as set forth in claims 11 wherein said bearing support comprises
a bearing assembly comprising
an inner race in slidable contact with the propeller shaft;
an outer support member;
an elastic damping member sandwiched between said inner race and aid outer support member and joined to both;
means to move said bearing assembly in a direction along the axis of the propeller shaft.

13. The propeller support system as set forth in claim 12 wherein said means to move said bearing assembly in a direction along the axis of the propeller shaft comprises”
said outer support member having a rack gear; and
a motor assembly with an output shaft having a pinion gear in engagement with said rack gear.
